(19) United States
(12) Patent Application Publication
(10) Pub. No.: US 2010/0288979 A1
(43) Pub. Date: Nov. 18, 2010

(54) ELECTROMAGNETIC SHIELDING MATERIAL AND METHOD FOR MANUFACTURING THE SAME

(75) Inventor: WU-YEN TSOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/511,081

(22) Filed: Jul. 29, 2009

(30) Foreign Application Priority Data
May 12, 2009 (CN) 200910302251.4

(51) Int. Cl. H01B 1/22; H01B 1/00; H01B 1/04

(52) U.S. Cl. 252/502; 252/500; 252/513; 252/514; 252/512

(57) ABSTRACT

An electromagnetic shielding material includes conductive particles, an antioxidant, and conductive adhesive bonding the conductive particles and the antioxidant together. Volume of the conductive particles accounts for total volume of the electromagnetic shielding material in a range from about 85% to about 92%, volume of the antioxidant accounts for the total volume of the electromagnetic shielding material in a range from about 3% to about 5%, and volume of the conductive adhesive accounts for the total volume of the electromagnetic shielding material in a range from about 5% to about 10%.

### BACKGROUND

1. Technical Field

The present disclosure relates to electromagnetic shielding materials and manufacturing methods, and in particular, to an electromagnetic shielding material and a method for manufacturing the electromagnetic shielding material.

2. Description of Related Art

Electronic devices are increasingly prone to electromagnetic interference. To reduce electromagnetic interference, many electronic components in an electronic devices, should maintain a good connection to ground. However, due to imperfect manufacturing techniques, minor defects, such as a functional hole in a shell of an electronic component may release electromagnetic waves. Furthermore, a gap in the shell of the electronic component may prevent the electronic component from connecting to ground, which may severely affect electromagnetic testing.

### BRIEF DESCRIPTION OF THE DRAWINGS

FIG. 1 is a schematic diagram of an embodiment of an electronic device with a gap.

FIG. 2 is a schematic diagram of an embodiment of an electromagnetic shielding element made of electromagnetic shielding material, the electromagnetic shielding element covering the gap of the electronic device of FIG. 1.

FIG. 3 is a flowchart of an embodiment of a method for manufacturing the electromagnetic shielding material of FIG. 2.

### DETAILED DESCRIPTION

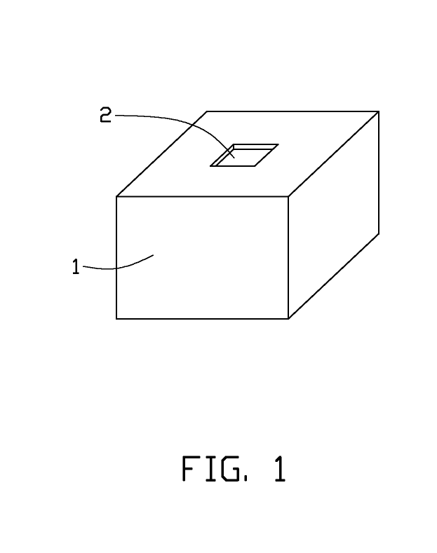

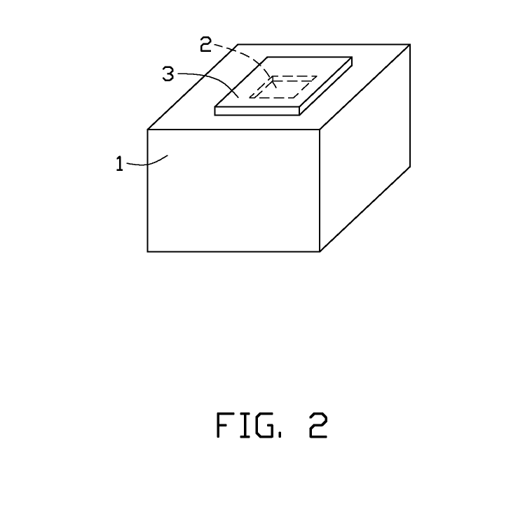

Referring to FIGS. 1 and 2, an exemplary embodiment of an electromagnetic shielding element 3 is made of an electromagnetic shielding material. The electromagnetic shielding material includes conductive particles, an antioxidant protecting the conductive particles from being oxidated, and conductive adhesive bonding the conductive particles and the antioxidant together. In one embodiment, volume of the conductive particles accounts for total volume of the electromagnetic shielding material in a range from about 85% to about 92%. Volume of the antioxidant accounts for the total volume of the electromagnetic shielding material in a range from about 3% to about 5%. Volume of the conductive adhesive accounts for the total volume of the electromagnetic shielding material in a range from about 5% to about 10%.

The conductive particles may be made of at least one conductive powder selected from the group consisting of copper, silver, aluminum, nickel, steel, and graphite powders. Any of these conductive powders may be used alone or in combination of two or more. In other embodiments, the conductive particles may be made of other conductive powders or their mixtures having excellent conductivity and high stabilization under standard conditions for temperature and pressure (STP).

The antioxidant protects the conductive particles from being oxidated by air, to keep excellent conductivity property of the conductive particles. The antioxidant is made of at least one compound selected from the group consisting of benzotriazole, hindered phenol, polyolefin in hindered phenol series, and methyl benzotriazole. Any of these compounds may be used alone or combination of two or more.

The conductive adhesive bonds the conductive particles and the antioxidant together to form a mixture having excellent conductivity and plasticity properties and low viscosity. In one embodiment, the conductive adhesive is made of at least one compound selected from the group consisting of silver epoxy resin, epoxy resin, conductive silver colloid, polyacetylene, polyaniline, polythiophene, polystyrene, and polypyrrole. Any of these compounds may be used alone or combination of two or more.

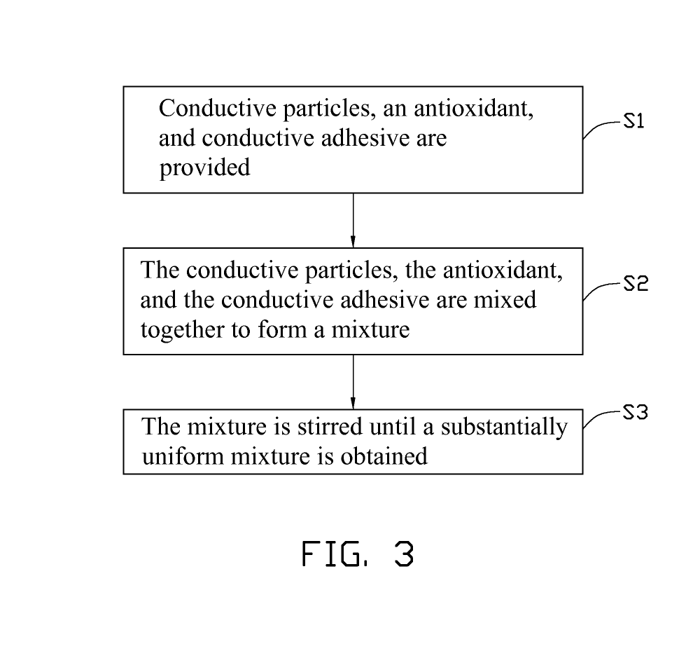

Referring to FIG. 3, a method for manufacturing the electromagnetic shielding material includes the following steps, in accordance with an embodiment.

In step S1, the conductive particles, the antioxidant, and the conductive adhesive are provided at a certain rate complying with the above mentioned ranges. In one embodiment, the volume proportion of the conductive particles may be 90%, the volume proportion of the antioxidant may be 4%, and the volume proportion of the conductive adhesive may be 6%.

In step S2, the conductive particles, the antioxidant, and the conductive adhesive are mixed together to form a mixture.

In step S3, the mixture is stirred until a substantially uniform mixture is obtained.

Referring to FIG. 1 again, when an electromagnetic compatibility test is performed on an electronic device 1 with a gap 2, electromagnetic waves generated by the electronic device 1 could escape through the gap 2 causing test failure.

Referring to FIG. 2, due to the conductive particles and the conductive adhesive having excellent conductive property, the electronic shielding element 3 made of the electromagnetic shielding material has a good conductive property. Because of the conductive adhesive has a low viscosity, the electronic shielding element 3 has good plasticity, and can be shaped into many different ways. Additionally, the conductive particles in the electronic shielding element 3 are protected from oxidation. When the electromagnetic shielding material is made into the electromagnetic shielding element 3 having a shape matching the gap 2 and covers the gap 2 properly, the electromagnetic waves cannot escape through the gap 2, and the electromagnetic compatibility test can be properly performed. After testing of the electronic device 1 is completed, the electromagnetic shielding element 3 can be easily taken away from the gap 2, and shaped to cover or block other gaps. In summary, the electromagnetic shielding material with changeable shape and excellent conductivity can be repeatedly used to assist in electromagnetic compatibility tests.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An electromagnetic shielding material, comprising:
conductive particles;
an antioxidant protecting the conductive particles from being oxidated by air; and
conductive adhesive bonding the conductive particles and the antioxidant together;
wherein volume of the conductive particles accounts for total volume of the electromagnetic shielding material in a range from about 85% to about 92%, volume of the antioxidant accounts for the total volume of the electromagnetic shielding material in a range from about 3% to about 5%, and volume of the conductive adhesive accounts for the total volume of the electromagnetic shielding material in a range from about 5% to about 10%.

2. The material of claim 1, wherein the conductive particles are made of at least one conductive powder selected from the group consisting of copper, silver, aluminum, nickel, steel, and graphite powders.

3. The material of claim 1, wherein the antioxidant is made of at least one compound selected from the group consisting of benzotriazole, hindered phenol, polyolefin in hindered phenol series, and methyl benzotriazole.

4. The material of claim 1, wherein the conductive adhesive is made of at least one compound selected from the group consisting of silver epoxy resin, epoxy resin, conductive silver colloid, polyacetylene, polyaniline, polythiophene, polystyrene, and polypyrrole.

5. A method for manufacturing an electromagnetic shielding material, comprising:
providing conductive particles, an antioxidant, and conductive adhesive;
mixing the conductive particles, the antioxidant, and the conductive adhesive together to form a mixture; and
stirring the mixture to obtain a substantially uniform mixture;
wherein the antioxidant protects the conductive particles from being oxidated by air, the conductive adhesive bonds the conductive particles and the antioxidant together; and
wherein volume of the conductive particles accounts for total volume of the electromagnetic shielding material in a range from about 85% to about 92%, volume of the antioxidant accounts for the total volume of the electromagnetic shielding material in a range from about 3% to about 5%, and volume of the conductive adhesive accounts for the total volume of the electromagnetic shielding material in a range from about 5% to about 10%.

6. The method of claim 5, wherein the conductive particles are made of at least one conductive powder selected from the group consisting of copper, silver, aluminum, nickel, steel, and graphite powders.

7. The method of claim 5, wherein the antioxidant is made of at least one compound selected from the group consisting of benzotriazole, hindered phenol, polyolefin in hindered phenol series, and methyl benzotriazole.

8. The method of claim 5, wherein the conductive adhesive is made of at least one compound selected from the group consisting of silver epoxy resin, epoxy resin, conductive silver colloid, polyacetylene, polyaniline, polythiophene, polystyrene, and polypyrrole.
